(19) United States
(12) Patent Application Publication
(10) Pub. No.: US 2022/0121251 A1
(43) Pub. Date: Apr. 21, 2022

(54) SWAPPABLE ADAPTER CAGES FOR REMOVABLE DEVICES

(71) Applicant: QUANTA COMPUTER INC., Taoyuan City (TW)

(72) Inventors: Chun CHANG, Taoyuan City (TW); Wei-Pin CHEN, Taoyuan City (TW); Kai-Yuan CHUANG, Taoyuan City (TW); Jyue HOU, Taoyuan City (TW)

(21) Appl. No.: 17/162,500

(22) Filed: Jan. 29, 2021

Related U.S. Application Data
(60) Provisional application No. 63/094,186, filed on Oct. 20, 2020.

(51) Int. Cl. G06F 1/18

(52) U.S. Cl. CPC G06F 1/187

(57) ABSTRACT

A computer chassis includes a first ha frame having a first opening and a second bay frame disposed adjacent to the first bay frame. The second bay frame has a second opening of a same size as the first opening. The first bay frame and the second bay frame a both configured to receive one of a first adapter cage and a second adapter cage. The first adapter cage is for one or more first removable devices of a first form factor and the second adapter cage is for a plurality of second removable devices of a second form factor. The second form factor is different from the first form factor.

### CROSS-REFERENCE TO RELATED APPLICATION

This application claims priority under 35 U.S.C. § 119 to U.S. Provisional Application No. 63/094,186, entitled “SWAPPABLE STORAGE MODULE”, filed on Oct. 20, 2020. The contents of that application are hereby incorporated by reference in their entirety.

### FIELD OF THE INVENTION

The present disclosure relates to adapter cages. More specifically, the present disclosure relates to swappable adapter cages for inserting different types of removable devices into a standardized bay frame of a computing device.

### BACKGROUND

In current computing devices, a computer chassis can have different bay modules associated with different types of hardware. The shape and size of the hardware typically varies where a particular bay module can only accommodate limited types and subtypes of hardware. For example, a bay module can be limited to particular types of storage devices (e.g., hard disc drive or HDD, solid-state drive or SSD) that can be inserted. The bay module can further be limited to a subtype of a storage device type, such as E1.S or E3 for SSD devices.

Accordingly, there is a need for increased flexibility for bay modules of a computer chassis to accommodate different removable devices.

### SUMMARY

The term embodiment and like terms are intended to refer broadly to all of the subject matter of this disclosure and the claims below. Statements containing these terms should be understood not to limit the subject matter described herein or to limit the meaning or scope of the claims below. Embodiments of the present disclosure covered herein are defined by the claims below, not this summary. This summary is a high-level overview of various aspects of the disclosure and introduces some of the concepts that are further described in the Detailed Description section below. This summary is not intended to identify key or essential features of the claimed subject matter; nor is it intended to be used in isolation to determine the scope of the claimed subject matter. The subject matter should be understood by reference to appropriate portions of the entire specification of this disclosure, any or all drawings and each claim.

According to one embodiment, a computer chassis comprises a first bay frame having a first opening, and a second bay frame disposed adjacent to the first bay frame. The second bay frame has a second opening that is of the same size as the first opening. The first bay frame and the second bay frame are both configured to receive one of a first adapter cage and a second adapter cage. The first adapter cage is for one or more first removable devices of a first form factor. The second adapter cage is for a plurality of second removable devices of a second form factor. The second form factor is different from the first form factor.

A further aspect of the embodiment includes the first bay frame and the second bay frame being of the same shape and size.

According to another embodiment, a bay frame for a computer chassis comprises a top wall, a bottom wall, a left wall, and the right wall. The left wall and the right wall are connected to the top wall and the bottom wall to define an interior space and a rectangular opening. The rectangular opening is configured to receive both a first adapter cage and a second adapter cage. The first adapter cage is for one or more first removable devices of a first form factor. The second adapter cage is for a plurality of second removable devices eta second form factor different from the first form factor.

A further aspect of the embodiments includes the first adapter cage being configured for the one or more first removable devices to be inserted into the first adapter cage prior to the first adapter cage being received in the bay frame(s). Another aspect of the embodiments includes the bay frame(s) being configured to receive storage devices having an E3.S form factor. Still another aspect of the embodiments includes the second adapter cage being configured for the plurality of second removable devices to be inserted into the second adapter cage prior to the second adapter cage being received in the bay frame(s). Still another aspect of the embodiments includes the one or more first removable devices including hard disk drives (HDD) and the plurality of second removable devices including solid-state drives (SSD).

A further aspect of the embodiments includes the first form factor is E1.S and the second form factor is 2.5 HDD. Another aspect of the embodiments includes the first form factor being Open Compute Project (OCT) 3.0 and the second form factor being E1.S. Another aspect of the embodiments includes the first form factor being OCP 3.0 and the second form factor being 2.5 HDD.

A further aspect of the embodiments includes the first adapter cage and the second adapter cage having a slide fit with interior surfaces of the bay frame(s). Another aspect of the embodiments includes the first adapter cage being secured to the bay frame with a screw when disposed within an interior space of the bay frame. Another aspect of the embodiments includes the second adapter cage being secured to the bay frame with a screw when disposed within an interior space of the bay frame. Still another aspect of the embodiments includes the first adapter cage being secured to the bay frame with a plunger lock when disposed within an interior space of the bay frame. Still another aspect of the embodiments includes the second adapter cage being secured to the bay frame with a plunger lock when disposed within an interior space of the bay frame.

The above summary is not intended to represent each embodiment or every aspect of the present disclosure. Rather, the foregoing summary merely provides an example of some of the novel aspects and features set forth herein. The above features and advantages, and other features and advantages of the present disclosure, will be readily apparent from the following detailed description of representative embodiments and modes for carrying out the present invention, when taken in connection with the accompanying drawings and the appended claims.

### BRIEF DESCRIPTION OF THE DRAWINGS

The disclosure will be better understood from the following description of embodiments together with reference to the accompanying drawings.

FIG. 1 depicts an exploded top perspective view of portion of an exemplary computer chassis with a plurality of bay frames for receiving different adapter cages and different types of removable devices, according to sonic implementations of the present disclosure.

FIG. 2 depicts a top perspective view of a portion of a computer chassis showing the insertion and removal of exemplary removable storage devices for an adapter cage disposed in a bay frame, according to some implementations of the present disclosure.

FIG. 3A depicts a top perspective view of a portion of a computer chassis showing the insertion and removal of exemplary removable storage devices for another adapter cage disposed in a bay frame, according to some implementations of the present disclosure.

FIG. 3B depicts a top perspective view of the exemplary removable storage device from FIG. 3A including a removable storage device carrier, according to some implementations of the present disclosure.

FIG. 4 depicts a top perspective view of an exemplary removable device being removed from an adapter cage, according to some implementations of the present disclosure.

FIG. 5 depicts a top perspective view of a portion of a computer chassis showing an exemplary removable storage device being removed from a bay frame, according to some implementations of the present disclosure.

FIGS. 6 to 8 depict top perspective views of portions of computer chassis showing exemplary adapter cages being inserted into and secured to a bay frame, according to some implementations of the present disclosure.

FIGS. 9A to 9D depict top perspective views of a portion of a computer chassis showing the removal of a first adapter cage and first removable devices from a bay frame and the insertion of a second adapter cage and second removable devices into the same bay frame, according to some implementations of the present disclosure.

The present disclosure is susceptible to various modifications and alternative forms. Some representative embodiments have been shown by way of example in the drawings and will be described in detail herein. It should be understood, however, that the invention is not intended to be limited to the particular forms disclosed. Rather, the disclosure is to cover all modifications, equivalents, and alternatives falling within the spirit and scope of the invention as defined by the appended claims.

### DETAILED DESCRIPTION

The various embodiments are described with reference to the attached figures, where like reference numerals are used throughout the figures to designate similar or equivalent elements. The figures are not drawn to scale, and they are provided merely to illustrate the instant invention, it should be understood that numerous specific details, relationships, and methods are set forth to provide a full understanding. One having ordinary skill in the relevant art, however, will readily recognize that the various embodiments can be practiced without one or more of the specific details, or with other methods. In other instances, well-known structures or operations are not shown in detail to avoid obscuring certain aspects of the various embodiments. The various embodiments are not limited by the illustrated ordering of acts or events, as some acts may occur in different orders and/or concurrently with other acts or events. Furthermore, not all illustrated acts or events are required to implement a methodology in accordance with the present invention.

Elements and limitations that are disclosed, for example, in the Abstract, Summary, and Detailed Description sections, but not explicitly set forth in the claims, should not be incorporated into the claims, singly, or collectively, by implication, inference, or otherwise. For purposes of the present detailed description, unless specifically disclaimed, the singular includes the plural and vice versa. The word “including” means “including without limitation.” Moreover, words of approximation, such as “about,” “almost,” “substantially,” “approximately,” and the like, can be used herein to mean “at,” “near,” or “nearly at,” or “within 3-5% of,” or “within acceptable manufacturing tolerances,” or any logical combination thereof, for example.

With regards to the present disclosure, the terms “computing device” refers to any electronically-powered or battery-powered equipment that has hardware, software, and/or firmware components, where the software and/or firmware components can be configured for operating features on the device. The term “coupled” means connected, whether directly or indirectly through intervening components, and is not necessarily limited to physical connections. The connection can be such that the objects are permanently connected or releasably connected. The term “substantially” is defined to be essentially conforming to the particular dimension, shape, or other word that substantially modifies, such that the component need not be exact. For example, substantially cylindrical means that the object resembles a cylinder, but can have one or more deviations from a true cylinder.

The present disclosure relates to swappable adapter cages that allow the insertion of different types of hardware devices into a standardized bay module of a computing device, including a server device. The mappable adapter cages being slidable or otherwise insertable into standardized bay modules is advantageous because it provides flexibility for assembling and making, changes to computing device configurations. For example, for a computing device with standardized bay frames in the computer chassis accessible from the front or back of the computing device, the present disclosure allows the bay frames to be easily converted via an adapter cage to accommodate removable devices with a different form factor (e.g., size, configuration, arrangement that determines physical compatibility or interchangeability). In some implementations, a bay frame sized to accommodate a hardware device having an E3.s form factor can be converted, using an adapter cage or similar carrier, to accommodate hardware having another form factor, such as E1.s, OCP 3.0, HDD, and others. The benefits include providing more efficient assembly of a computing device that can further he easily serviced and repurposed.

In some implementations, a computer chassis can include a first bay frame having a first opening and a second bay frame disposed adjacent to the first bay frame. The second bay frame has a second opening that is of the same size as the first opening. The first opening and second opening are easily accessible from the front or back of the computer chassis. The first bay frame and the second bay frame are both configured to receive one of a first adapter cage and a second adapter cage. The first adapter cage is for one or more first removable hardware devices of a first form factor. The second adapter cage is for a plurality of second removable hardware devices of a second form factor. The second form factor is different from the first form factor. In some aspects, the first bay frame and the second bay frame have the same shape and size.

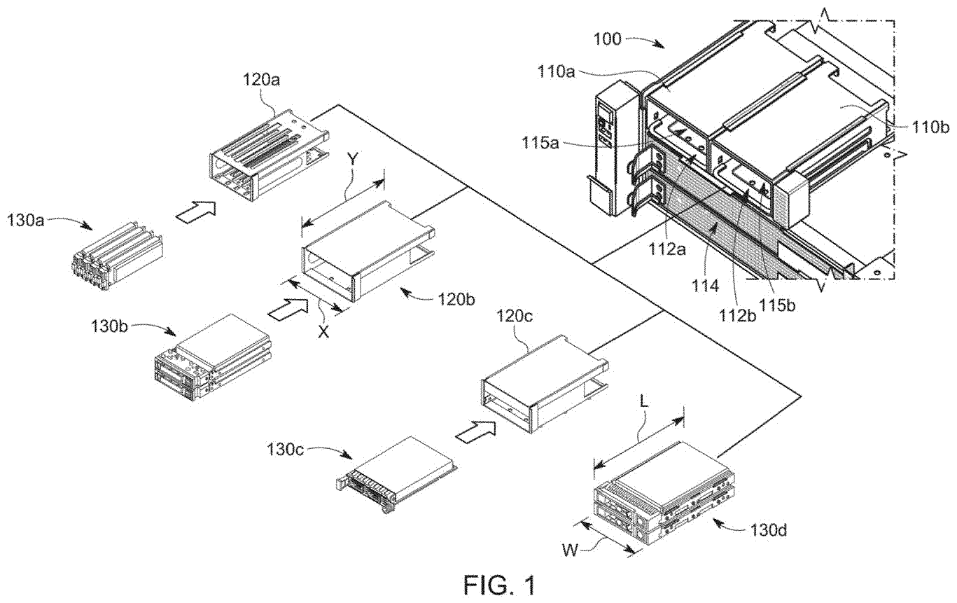

Turning now to FIG. 1, an exploded top perspective view of a portion of an exemplary computer chassis 100 is depicted that includes a plurality of bay frames, such as bay frames 110a, 110b, for receiving different adapter cages, such as exemplary adapter cages 120a, 120b, 120c, and different types of removable devices, such as exemplary removable storage devices 130a, 130b, 130d or an exemplary removable network interface card (NIC) device 130c. In some implementations, other types of hardware devices of a certain form factor can be accommodated by the bay frame(s) or the adapter cage(s).

Each of the adapter cages 120a-c is configured to receive respective removable devices 130a-c having a different form factor. For example, the adapter cage 120 is configured to receive a plurality of E1.s solid state drive (SSD) storage devices 130a that are vertically aligned adjacent to each other. Similarly, the adapter cage 120b is configured to receive a plurality of 2.5 high-density drive (HDD) storage devices 130b stacked on top of each other. Likewise, the adapter cage 120c is configured to receive a single Open Compute Project (OCP) 3.0 NIC device 130c. Each bay frame 110a-b is sized to a particular form factor standard and can receive any one of the adapter cages 120a-c that can be inserted by being slid into interior spaces 115a, 115b of the bay frames 110a-b.

The bay frames 110a-b are disposed adjacent to each other on the computer chassis 100. The bay frames 110a-b have respective openings 112a, 112b at the front end 114 of the computer chassis 100. The openings 112a, 112b allow access to the respective interior spaces 115a, 115b of the bay frames 110a, 110b. The openings 112a, 112b have a similar shape and size such that anyone of adapter cages 120a-c or removable storage devices 130d can interchangeably occupy and be operational in any one of bay frames 110a-b.

The plurality of bay frames, such as the bay frames 110a-b, are sized to receive removable devices having, the same form factor representing the largest removable device(s) that the plurality of bay frames are configured to receive without the use of an adapter cage (e.g., adapter cages 120a-c). The removable storage device 130d provides an example of a removable device used to size the bay frames 110a-b. The removable storage device 130d includes two stacked E3.s SSDs having a maximum width, W, and a maximum length, L, which are generally greater than the width and length dimensions of all the other removable devices 130a-c. In some implementations, the width, W, and the length L, of the removable storage device 130d are similar to, or the same as, the corresponding maximum width, X, and maximum length, Y, of the individual adapter cages 120a-c. The removable storage device 130d can be inserted and removed with a sliding fit into and out of any one of the bay frames 110a-b, without the need for an adapter cage. In some implementations. an adapter cage, such as adapter cage 120b, has a width of approximately 80+/−0.2 mm, and a height of approximately 37+/−0.2 mm. The corresponding bay frame 110b has an opening 112b having a corresponding width of approximately 81+/−0.2 mm and height of approximately 38+/−0.2 mm.

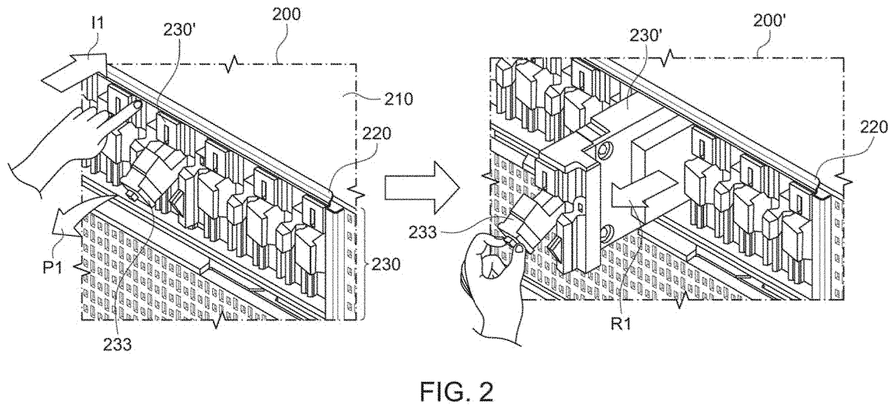

Referring to FIG. 2, a top perspective view of a portion of a computer chassis 200 is provided with a close-up view 200′ showing a single removable storage device 230′ among a plurality of removable storage devices 230 disposed in an adapter cage 220. The single removable storage device 230′ can be inserted by applying a force in direction, I1, and removed by applying a force in direction, R1. The adapter cage 220 is shown inserted into a bay frame 210, similar to the bay frames 110a, 110b.

The single removable storage device 230′ includes an exemplary lever component 233 that can be used to disengage the removable storage device 230′ by pulling the lever component 233 in direction, P1. Once disengaged, further pulling of the lever component 233 in direction, P1, causes the removable storage device 230′ to slide out of the adapter cage 220 in direction R1. Any one of the removable storage devices 230 can individually be inserted or removed from the bay frame 210 without the entire adapter cage 220 having to be removed. Relatedly, after the adapter cage 220 is inserted into the bay frame 210 of the computer chassis 200, the removable storage devices 230 can individually be inserted into the adapter cage 220.

The plurality of removable storage devices 230 depicted in FIG. 2 are E1.s SSD storage devices, similar to removable storage devices 130a in FIG. 1. The adapter cage 220 is also similar to the adapter cage 120a from FIG. 1. However, different removable storage or hardware devices and different adapter cages of select form factors with similar insertion and removal operations are contemplated by the present disclosure.

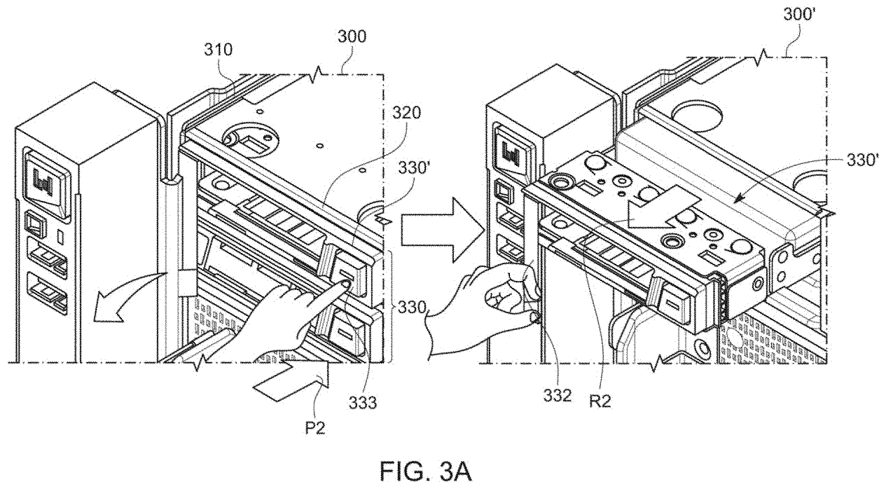

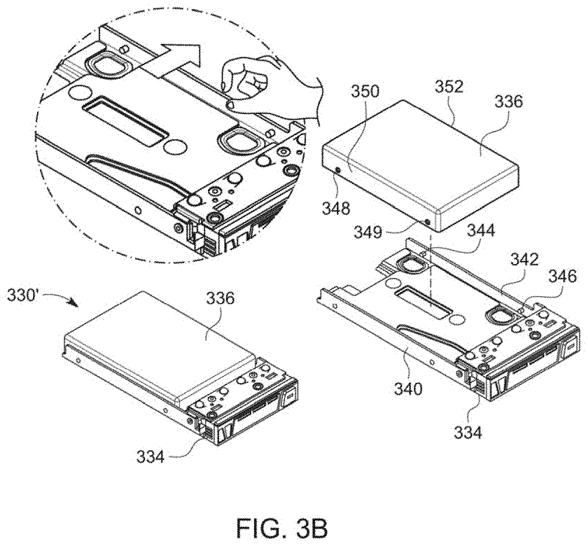

Referring to FIG. 3A, a top perspective view of a portion of a computer chassis 300 is provided with a close-up view 300′ showing a single, removable storage device assembly 330′ of a plurality of removable storage devices assemblies 330 within an adapter cage 320. The single removable storage device assembly 330′is depicted as being removed by applying a force in direction, R2. The adapter cage 320 is disposed in a bay frame 310, similar to 110a, 110b.

The single removable storage device assembly 330′ includes an exemplary push component 333 for releasing the removable storage device assembly 330′ from the adapter cage 320 by pressing the push component in direction, P2, to release a lever 332. Once the lever 332 is released, the removable storage device assembly 330′ can be pulled out of the adapter cage 320 in direction, R2, by the removable storage device assembly 330′ sliding out of the adapter cage 320. Anyone of the removable storage device assemblies 330 can individually be inserted or removed from the bay frame 310 without the entire adapter cage 320 having to be removed. Relatedly, after the adapter cage 320 is inserted into the bay frame 310 of the computer chassis 300, the removable storage device assemblies 330 can individually be inserted into the adapter cage 320.

The plurality of removable storage devices assemblies 330 depicted in FIG. 3A include 2.5 HDD storage devices, similar to the storage devices 130b in FIG. 1. In some implementations, the adapter cage 320 is similar to the adapter cage 120b from FIG. 1. However, different removable storage or hardware devices and different adapter cages of select form factors with similar insertion and removal operations are contemplated by the present disclosure.

Referring to FIG. 3B, a top perspective view of the exemplary removable storage device assembly 330′ from FIG. 3A is provided including a removable storage device carrier 334 into which a 2.5 HDD storage device 336 is secured. In some implementations, the removable storage device 336 is secured in the removable storage device carrier 334 by two side plates 340, 342 that have a plurality of pins, such as pins 344, 346 (additional pins are on side plate 340 that are similar to the pins 344, 346 but not visible), that engage respective receiving holes, such as receiving holes 348, 349, on the side walls of the storage device, such as a side wall 350. In some implementations, one or more of side plates 340, 342 may rotate or pivot outwardly allowing the insertion or removal of the removable storage device 336 from the removable storage device carrier 334 with the plurality of pins on side plates 340, 342 engaging or disengaging with respective receiving holes on opposing side walls (e.g., side wall 350 and opposing side wall 352 that is not visible) of the removable storage device 336.

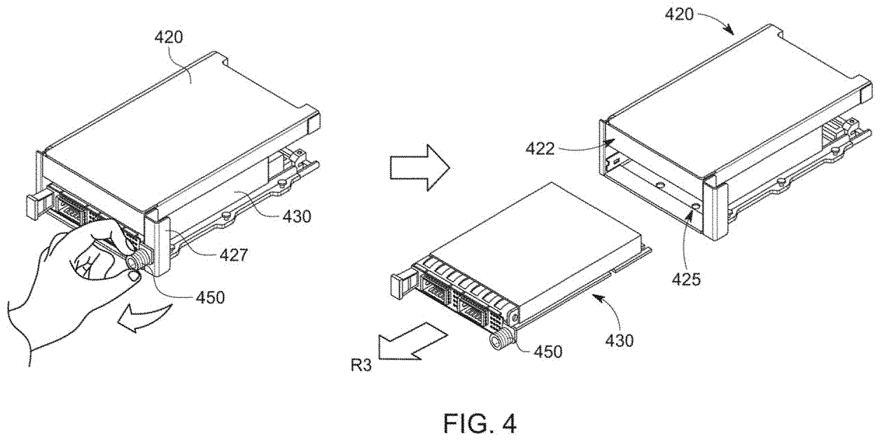

Referring to FIG. 4, a top perspective view is provided of another exemplary removable NIC device 430 that was previously inserted and is depicted being removed from an adapter cage 420. The removable NW device 430 and the adapter cage 420 have an OCP 3.0 form factor, similar to the removable NIC device 130c and the adapter cage 120c in FIG. 1 that can be inserted. and removed from either of bay frames 110a, 110b. The removable NIC device 430 slides into and out of an opening 425 on the front side 422 of the adapter cage 420, which is sized specifically to an OCP 3.0 form factor. The removable NIC device 430 includes a screw 450 that is manually tightened and loosened to engage and disengage the screw 450 from a threaded hole to (not shown) in a securing plate 427 of the adapter cage 420. Once the screw 450 is fully loosened and disengaged from the securing plate 427, the removable NIC device 430 is removed by applying a force in direction, R, out of the opening 425 of the adapter cage 420.

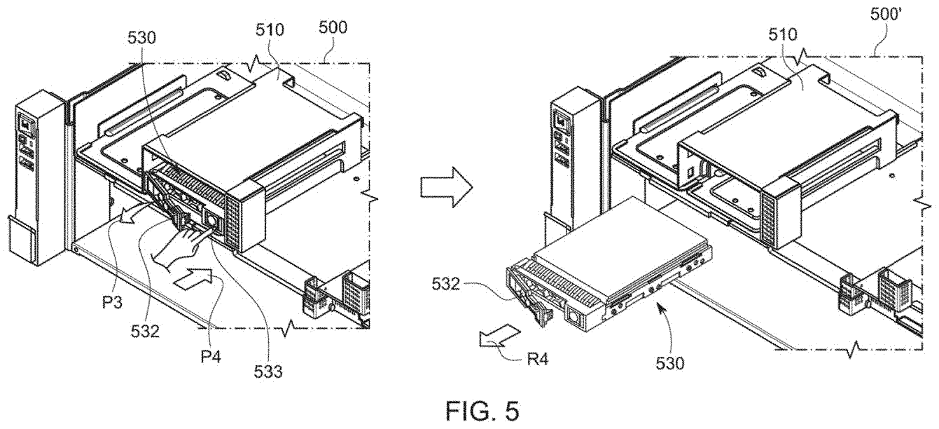

Referring to FIG. 5, a top perspective view of a portion of a computer chassis 500 with a close-up view 500′ is provided. The close-up view 500′ shows a removal in direction, R4, of a single removable storage device 530 from a bay frame 510 of the computer chassis 500. The bay frame 510 is similar to the bay frames 110a, 110b described above.

The removable storage device 530 includes an exemplary push button component 533 that can be used to release a lever 532 on the removable storage device 530 by urging the push button component 533 in direction, P3. Once the lever 532 is released, a pull force is applied to the lever 532 in direction P3 that causes the removable storage device 530 to slide out of the bay frame 510 in direction R4. The removable storage device 530 can be inserted and removed with a sliding fit into or out of bay frame 510 without the need for an adapter cage. In some implementations, to provide for the sliding fit, an opening of the bay frame 510 may be approximately 1 mm wider and 1 mm taller than the respective width (e.g., see W in FIG. 1) and height of the removable storage device 530 that is inserted into the bay frame 510.

The removable storage device 530 depicted in FIG, 5 is an E3.s SSD storage device, similar to the removable storage devices 130d in FIG. 1, though other removable storage devices and hardware modules are contemplated. The bay frame 510 is sired to receive removable storage devices 530 each having the same form factor representing the largest removable device(s) the bay frame 510 can operationally receive without the use of an adapter cage.

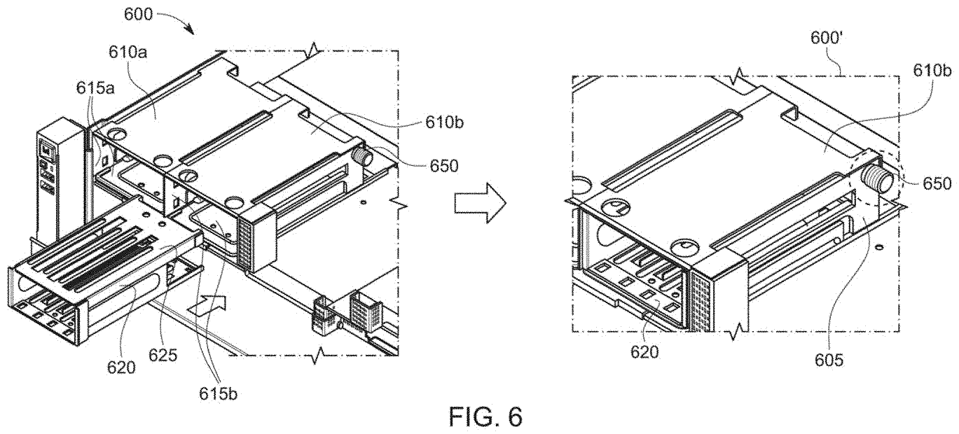

Referring to FIGS. 6 to 8, top perspective views are provided of a portion of a computer chassis 600, including close-up views 600′, depicting bay frames 610a, 610b and adapter cages 620, 720, 820 being inserted into and secured by different fasteners 650, 750, 850a, 850b to the bay frame 610b. The adapter cage 620 is similar to the adapter cage 120a from FIG. 1 for E1.s storage devices. However, different removable devices and adapter cages with similar mechanisms for fastening an adapter cage to a bay frame are contemplated by the present disclosure.

Each bay frame 610a-b is sized to receive the adapter cage 620, which has a slide lit with interior surfaces 615a, 615b of the bay frames 610a-b where there is a small clearance between exterior surfaces 625 of the adapter cage 620 and interior surfaces 615a-b of the bay frames 610ab. Because a slide fit allows for some movement of the adapter cage 620 within the bay frame 610a-b, securing mechanisms for the adapter cage are contemplated. In some implementations, to provide for the sliding fit, an opening of a bay frame may be approximately 1 mm wider and 1 mm taller than the respective width (e.g., see X in FIG. 1) and height of an adapter cage that is inserted into the bay frame.

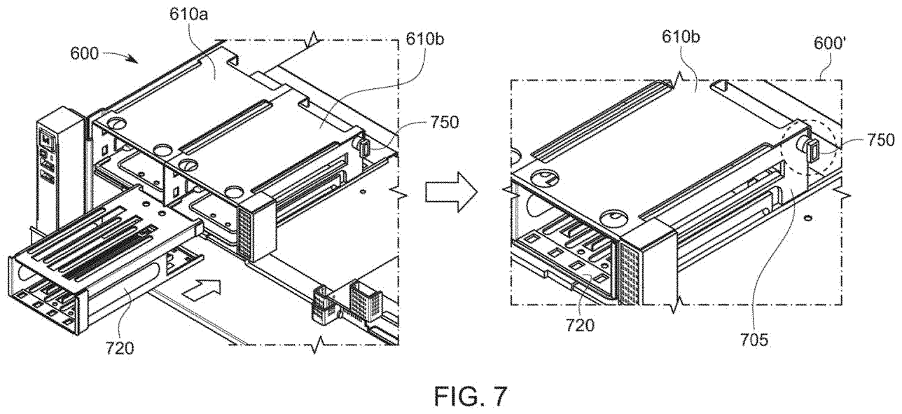

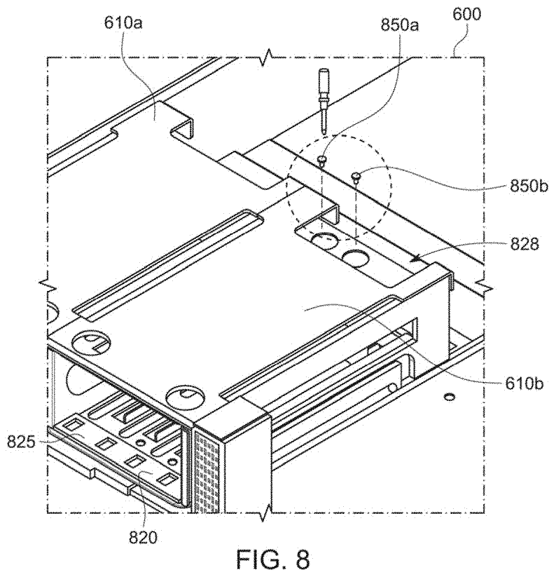

Referring to FIG. 6, a thumb screw fastener 650 is depicted that penetrates a side wall 605 of the bay frame 610b and engages the adapter cage 620 that is fully inserted into the bay frame 610b to secure the adapter cage 620 to the bay frame 610b. Referring to FIG. 7, plunger lock 750 is depicted that penetrates a side wall 705 of the bay frame 610b and engages an adapter cage 720 that is fully inserted into the bay frame 610b to secure the adapter cage 720 to the bay frame 610b. Referring to FIG. 8, a plurality of threaded screws 850a, 850b are depicted that penetrate a bottom wall 825 at a rear portion 828 of an adapter cage 820. The plurality of threaded screws 850a, 850b engage the bay frame 610b through the adapter cage 820 when the adapter cage 820 is fully inserted into the bay frame 610b and are aligned with corresponding receiving holes (not shown) in the bay frame 610b. Other mechanical fastening application are contemplated beyond the thumb screw fastener 650, the plunger lock 750, and the plurality of threaded screws 850a, 850b described above.

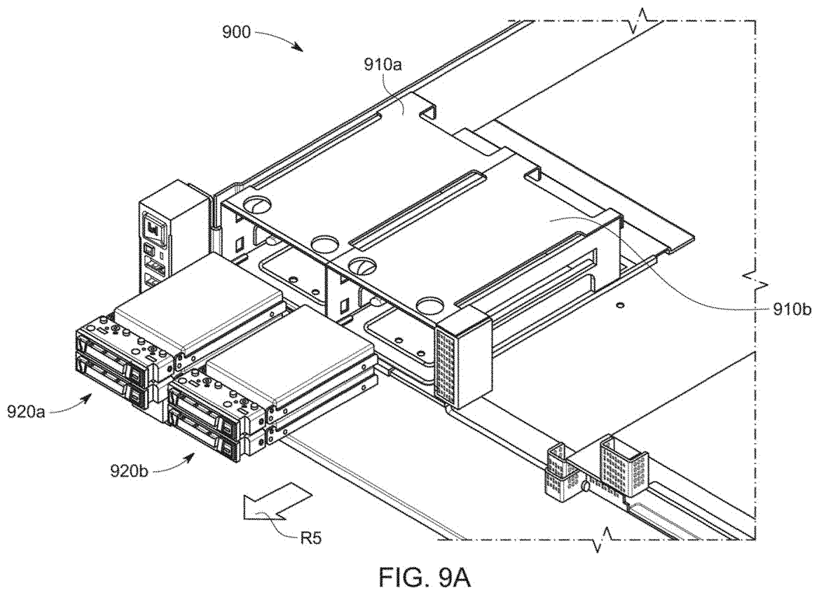

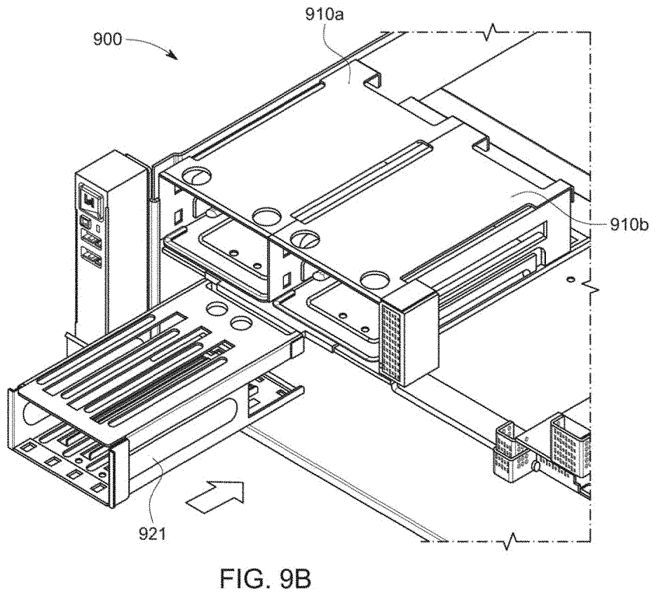

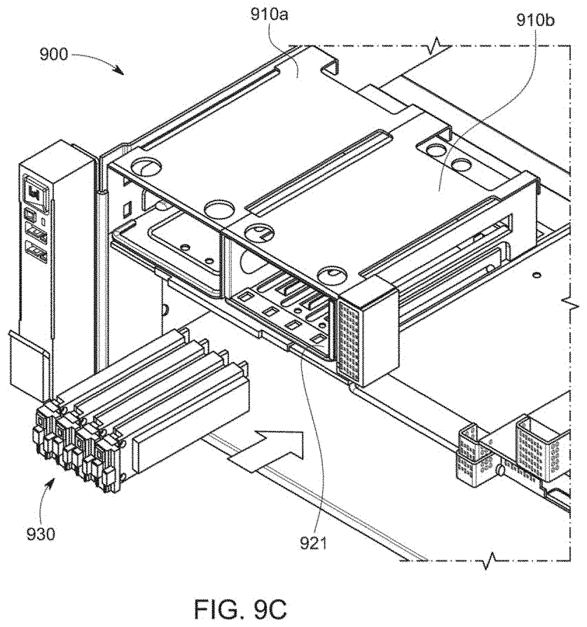

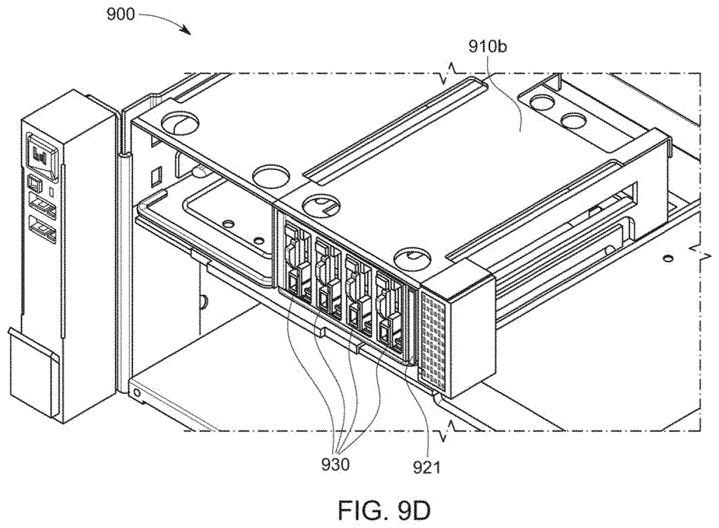

In FIGS. 9A to 9D, top perspective views of a portion of a computer chassis 900 are depicted, showing the swapping of removable devices, including the removal of stacked storage devices 920a, 920b from bay frames 910a, 910b and the insertion of an adapter cage 921 and second storage devices 930 into the bay frame 910b. The exemplary stacked removable storage devices 920a, 920b are similar to the E3.s SSD storage devices 130d, 530 discussed for FIGS. 1 and 5. The second removable storage devices 930 and adapter cage 921 are similar to the E1.s storage devices 130a, 230 discussed for FIGS. 1 and 2. The bay frames 910a, 910b are similar to the bay frames 110a, 110b discussed in FIGS. 1 and 2.

In FIG. 9A, the stacked storage devices 920a, 920b are removed from the bay frames 910a, 910b by applying a force to slide the stacked storage device in direction R5, out of the bay frames 910a, 910b. Then, in FIG. 9B, following, the removal of at least stacked storage device 920b from bay frame 910b, adapter cage 921 may be inserted via a slide fit into bay frame 910b. The adapter cage 921 can he mechanically secured into the bay frame 910b by a fastener as described in FIGS. 6 to 8, or for example, through the application of spring mechanisms, among other things, or by frictional forces between the exterior surfaces of the inserted adapter cage 921 and the interior surfaces of the bay frame 910b. Following the adapter cage 921 being secured in the bay frame 910b, FIG. 9C and 9D depict one or more removable storage devices 930 then being inserted into the adapter cage 921, which is secured within the bay frame 910b.

While various embodiments of the present invention have been described above, it should be understood that they have been presented by way of example only, and not limitation. Numerous changes to the disclosed embodiments can be made in accordance with the disclosure herein without departing from the spirit or scope. Thus, the breadth and scope of the present invention should not be limited by any of the above described embodiments. Rather, the scope of the invention should be defined in accordance with the following claims and their equivalents.

Although the invention has been illustrated and described with respect to one or more implementations, equivalent alterations, and modifications will occur to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application.

The terminology used herein is for the purpose of describing particular embodiments only and is not intended to be limiting. As used herein, the singular forms “a,” “an,” and “the” are intended to include the plural forms as well, unless the context clearly indicates otherwise. Furthermore, to the extent that the terms “including,”“includes,” “having,” “has,” “with,” or variants thereof are used in either the detailed description and/or the claims, such terms are intended to be inclusive in a manner similar to the term “comprising.”

Unless otherwise defined, all terms (including technical and scientific terms) used herein have the same meaning as commonly understood by on of ordinary skill in the art to which this invention belongs. Furthermore, terms, such as those defined in commonly used dictionaries, should be interpreted as having a meaning that is consistent with their meaning in the context of the relevant art and will not be interpreted in an idealized or overly formal sense unless expressly so defined herein.

What is claimed is:

1. A computer chassis comprising:
a first bay frame having a first opening; and
a second bay frame disposed adjacent to the first bay frame, the second bay frame having a second opening of a same size as the first opening,
wherein the first bay frame and the second bay frame are both configured to receive one of a first adapter cage for one or more first removable devices of a first form factor and a second adapter cage for a plurality of second removable devices of a second form Factor different from the first form factor.

2. The computer chassis of claim 1, wherein the first adapter cage is configured for the one or more first removable devices to be inserted into the first adapter cage prior to the first adapter cage being received in the first bay frame.

3. The computer chassis of claim 1, wherein the second adapter cage is configured for the plurality of second removable devices to be inserted into the second adapter cage prior to the second adapter cage being received in the second bay frame.

4. The computer chassis of claim 1, wherein the first bay frame and the second bay frame are configured to receive removable storage devices having an E3.S form factor.

5. The computer chassis of claim 1, wherein the one or more first removable devices include hard disk drives and the plurality of second removable devices includes solid-state drives.

6. The computer chassis of claim 1, wherein the first form factor is E1.S and the second form factor is 2.5 hard disk drive (HDD).

7. The computer chassis of claim 1, wherein the first form factor is Open Compute Project (OCP) 3.0 and the second form factor is E1.S.

8. The computer chassis of claim 1, wherein the first form factor is OCP 3.0 and the second form factor is 2.5 HDD.

9. The computer chassis of claim 1, wherein the first adapter cage and the second adapter cage have a slide fit with interior surfaces of the first bay frame and the second bay frame.

10. The computer chassis of claim 1, wherein the first adapter cage is secured to the first bay frame with a screw when disposed within an interior space of the first bay frame.

11. The computer chassis of claim 1, wherein the second adapter cage is secured to the first bay frame with a screw when disposed within an interior space of the first bay frame.

12. The computer chassis of claim 1, wherein the first adapter cage is secured to the first bay frame with a plunger lock When disposed within an interior space of the first bay frame.

13. The computer chassis of claim 1, wherein the second adapter cage is secured to the first bay frame with a plunger lock when disposed within an interior space of the first bay frame.

14. The computer chassis of claim 1, wherein the first bay frame and the second bay frame are of the same shape and size.

15. A bay frame for a computer chassis, the bay frame comprising:
a top wall and a bottom wall; and
a left wall and a right wall connected to the top wall and the bottom wall to define an opening and an interior space therein,
wherein the opening is configured to receive a first adapter cage for one or more first removable devices of a first form factor and a second adapter cage for a plurality of second removable devices of a second form factor different from the first form factor.

16. The bay frame of claim 15, wherein the first adapter cage is configured for the one or more first removable devices to be inserted into the first adapter cage prior to the first adapter cage being received in the bay frame.

17. The bay frame of claim 15, wherein the second adapter cage is configured for the plurality of second removable devices to be inserted into the second adapter cage prior to the second adapter cage being received in the bay frame.

18. The bay frame of claim 15, wherein the opening is sized to receive removable storage devices having an E3.S form factor.

19. The bay frame of claim 15, wherein the first adapter cage and the second adapter cage have a slide fit with interior surfaces of the bay frame.

20. The bay frame of claim 15, wherein the first adapter cage or the second adapter cage are secured to the bay frame with a screw or plunger lock when disposed within the interior space of the bay frame.
